(19) United States
(12) Patent Application Publication
(10) Pub. No.: US 2015/0289327 A1
(43) Pub. Date: Oct. 8, 2015

(54) SYSTEM AND METHOD FOR POWERING AND CONTROLLING A SOLID STATE LIGHTING UNIT

(71) Applicant: Lumenpulse Lighting Inc., Montreal (CA)

(72) Inventors: Gregory Campbell, Walpole, MA (US); Michael Chiasson, Roslindale, MA (US); Dale Reynolds, Hingham, MA (US)

(73) Assignee: LUMENPULSE LIGHTING INC., Montreal (CA)

(21) Appl. No.: 14/663,845

(22) Filed: Mar. 20, 2015

Related U.S. Application Data
(60) Provisional application No. 61/975,437, filed on Apr. 4, 2014.

(51) Int. Cl. H05B 33/08

(52) U.S. Cl. CPC H05B 33/0809; H05B 33/0845; H05B 33/0857; H05B 33/0887

(57) ABSTRACT

The present disclosure provides a lighting system. In one example, the lighting system comprises a circuit board including plural light emitting sets, each of the light emitting sets including one or more light emitting diodes, plural integrated circuits configured to receive a rectified sine waveform of a power source, and a dimmer circuit electrically coupled to the integrated circuits and configured to transmit a dimming signal to the integrated circuits. Each one of the integrated circuits is electrically coupled to a respective one of the light emitting sets. Each of the integrated circuits is configured to modify the rectified sine waveform into a truncated rectified sine waveform based on the dimming signal. Each of the integrated circuits is configured to turn on or off a number of the light emitting diodes included in a respective one of the light emitting sets based on the truncated rectified sine waveform.

### RELATED APPLICATION

This application claims the benefit of priority to U.S. Provisional Application No. 61/975,437, filed on Apr. 4, 2014, the entire contents of which are incorporated herein by reference for all purposes.

### BACKGROUND

The present disclosure relates generally to a lighting system and a method for driving the lighting system. More particularly, the present disclosure relates to a lighting system including light emitting diodes (LEDs) and a method for driving the LEDs without the need of a power supply.

Recent developments in lighting technologies include advances in efficiency and power of lighting systems. Some of the advanced lighting systems use, for example, light emitting diodes (LEDs). LEDs are available in various colors. They also have relatively high luminous efficiencies and long life times.

Nevertheless, existing LED systems have some limitations. For instance, the lighting systems that use LEDs may have an overall lifetime that is shorter than that of its LEDs due to the failure of other parts. Moreover, the light from these lighting systems may have a look and feel that is different from those of natural light or of traditional incandescent lights. The difference may exist for a full light profile or a dimmed light profile. As a result, a user may not be willing to use LED systems, despite their advantages. And even when a user decides to upgrade the lighting system in a building, the user may encounter practical and financial burdens. For example, instead of gradually replacing old incandescent lights that fail with new LED based lights, the user may have to replace all old lights at the same time to avoid inhomogeneous lighting that may result from the differences between the incandescent lights and the LED lights. The cost and burden of such a complete replacement may deter the use of new lighting systems, despite their advantages.

Moreover, many locations such as museums or libraries would benefit from a lighting system that can vary at different times and location in its color, color temperature, or luminosity. But, existing lighting systems may not provide such flexibilities.

### SUMMARY

The present disclosure provides a lighting system that is operable by directly using a AC power source, without using a power supply or a AC/DC converter.

In accordance with yet another aspect, a lighting system of the present disclosure includes a circuit board including a plurality of light emitting sets, each of the light emitting sets including one or more light emitting diodes; a plurality of integrated circuits configured to receive a rectified sine waveform of a power source, wherein each one of said plurality of integrated circuits is electrically coupled to a respective one of the light emitting sets; and a dimmer circuit electrically coupled to the integrated circuits and configured to transmit a dimming signal to the integrated circuits; wherein each of the integrated circuits is configured to modify the rectified sine waveform into a truncated rectified sine waveform based on the dimming signal; and wherein each of the integrated circuits is configured to turn on or off a number of the light emitting diodes included in a respective one of the light emitting sets based on the truncated rectified sine waveform.

In one embodiment, each of the light emitting sets can include at least one light emitting diode.

In one embodiment, one of the light emitting sets can include an equal number of light emitting diodes as another one of the light emitting sets.

In one embodiment, the system further can include a rectifier circuit electrically coupled to the integrated circuits and configured to generate the rectified sine waveform of the power source.

In one embodiment, the dimming signal can include at least one of a DMX signal, a digital addressable lighting interface (DALI) signal, a power-line communication signal, a global dimming signal having a voltage between 0-10 volts, a Bluetooth signal, a Bluetooth Low Energy signal, a WIFI signal, a Zigbee signal, and a visible light signal.

In one embodiment, the dimmer circuit can be electrically coupled to the integrated circuits through at least one circuit protector.

In one embodiment, the at least one circuit protector can include at least one of a capacitor, a Zener diode, an opto-isolator, and a combination thereof.

In one embodiment, each of the integrated circuits can be configured to sequentially turn on the respective one of the light emitting sets in a first quarter wave cycle of the rectified sine waveform and to sequentially turn off the respective one of the light emitting sets in a second quarter wave cycle of the rectified sine waveform following the first quarter cycle.

In one embodiment, each of the light emitting sets can include at least one white color light emitting diode.

In one embodiment, the light emitting sets can include at least one light emitting diode of a first color and at least one light emitting diode of a second color different from the first color.

In one embodiment, the first color can be white and the second color can be red.

In one embodiment, the light emitting sets can include at least one light emitting diode of a first color, at least one light emitting diode of a second color different from the first color, and at least one light emitting diode of a third color different from the first color and the second color.

In one embodiment, the first color can be white, the second color can be red, and the third color can be blue.

The above listed embodiments provide at least some of the following advantages. One key advantage allows for the removal of standard AC/DC power supplies that are traditionally found in solid state lighting systems. This allows products to become smaller, while simultaneously becoming more efficient, as the losses associated with traditional AC/DC conversion are nonexistent. Simultaneously, the components used in these systems remove the weakest link, e.g., the AC/DC power supply that includes electrolytic capacitors and inductors.

The elimination of the standard AC/DC power supply allows for a lower cost structure to allow for broadening adoption of the technology as well as increasing the overall life of the lighting units. Another advantage, is the dimming capabilities provide smooth, consistent, dimming without the need for complex, costly circuitry. Dimming LEDs in a even manner off of the rectified AC mains allows for significant advantages.

Another significant advantage to this technology is the ability, within a single system, to add multiple integrating circuits and dimming circuits. This enables simple, cost effective ways of control color, and color points, commonly only capable with complex, costly control infrastructure.

### BRIEF DESCRIPTION OF THE DRAWINGS

The foregoing and other objects, features and advantages will be apparent from the following more particular description of the embodiments, as illustrated in the accompanying drawings in which like reference characters refer to the same parts throughout the different views. The drawings are not necessarily to scale, emphasis instead being placed upon illustrating the principles of the embodiments.

FIG. 1 depicts an LED lighting system;

FIG. 2 is a block diagram of a lighting system using an ASIC according to some embodiments;

FIG. 3 is a block diagram of another lighting system using an ASIC according to some embodiments;

FIGS. 4A and 4B illustrate the basic functionality of LEDs powered directly from a high voltage AC source and controlled by a custom ASIC, according to some embodiments;

FIGS. 5A-5C include a schematic of a lighting system according to an embodiment;

FIGS. 6A-6D include a schematic of a lighting system according to another embodiment;

FIG. 7 depicts structures of two LEDs according to some embodiments;

FIG. 8 is a schematic of a dimmer mechanism according to some embodiments;

FIGS. 9A and 9B illustrate two types of relationships between dimmer input and output according to various embodiments;

FIG. 10 shows a schematic of a lighting system and its dimmer input according to an embodiment;

FIG. 11 shows a schematic of a lighting system and its dimming mechanism according to another embodiment;

FIG. 12 depicts a CIE 1931 chromaticity diagram;

FIGS. 13A and 13B show the measured dimming profile of an incandescent light source in a CIE diagram;

FIG. 14 shows a white LED board according to an embodiment;

FIGS. 15A and 15B show the measured dimming profile of a white LED light source in a CIE diagram;

FIG. 16 shows a bi-color LED board according to an embodiment;

FIGS. 17A and 17B show the measured dimming profile of a bi-color light source in a CIE diagram according to an embodiment;

FIG. 18A shows the measured dimming profile of a bi-color light source in a CIE diagram according another embodiment;

FIG. 18B shows some measurements for dimming profile of the bi-color light source of FIG. 18A;

FIG. 19 depicts a block diagram of a lighting system with more than one ASIC according to some embodiments;

FIG. 20 shows a tri-color LED board according to an embodiment;

FIGS. 21A and 21B show the measured dimming profile of a tri-color light source in a CIE diagram according to an embodiment; and

FIG. 21C shows a black body curve and exemplary dimming points, as implemented by a system similar to that discussed in FIGS. 21A and 21B.

### DETAILED DESCRIPTION

The following detailed description refers to the accompanying drawings. Wherever possible, the same or similar reference numbers are used in the drawings or in the description to refer to the same or similar parts. Also, similarly-named elements may perform similar functions and may be similarly designed, unless specified otherwise. Numerous details are set forth to provide an understanding of the described embodiments. The embodiments may be practiced without these details. In other instances, well-known methods, procedures, and components have not been described in detail to avoid obscuring the described embodiments.

While several exemplary embodiments and features are described here, modifications, adaptations, and other implementations may be possible, without departing from the spirit and scope of the invention. Accordingly, unless explicitly stated otherwise, the descriptions relate to one or more embodiments and should not be construed to limit the invention as a whole. This is true regardless of whether or not the disclosure states that a feature is related to “one,” “one or more,” “some,” or “various” embodiments. Instead, the proper scope of the invention is defined by the appended claims. Further, stating that a feature may exist indicates that the feature exists in one or more embodiments.

In this disclosure, the terms “include,” “comprise,” “contain,” and “have,” when used after a set or a system, mean an open inclusion and do not exclude addition of other, non-enumerated, members to the set or to the system. Moreover, as used in this disclosure, a subset of a set can include one or more than one, including all, members of the set.

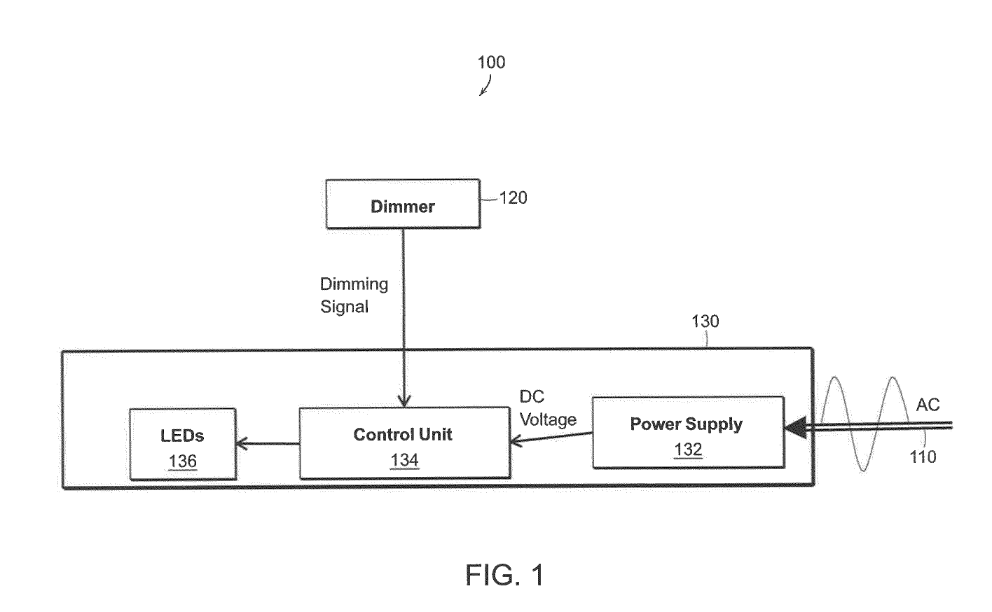

Various embodiments address one or more problems of the existing lighting systems. For example, the life time of existing lighting systems may be limited due to the failure of some non-lighting parts. FIG. 1 depicts an LED lighting system 100, which includes various lighting and non-lighting parts. System 100 includes an AC power line 110, a dimmer 120, and an LED assembly 130. LED assembly 130 includes a power supply unit 132, a control unit 134, and one or more LEDs 136. Power supply unit 132 may receive an AC voltage from power line 110, convert the AC voltage into a DC voltage (using, for example, an A/D converter), and deliver that voltage to control unit 134. Dimmer 120 delivers a dimming signal to control unit 134. Control unit 134 delivers DC voltage and current to LEDs 136. Control unit 134 may modify the delivered DC voltage and current based on the dimming signal. In some embodiments, control unit 134 includes a processor.

The life time of a lighting system may be limited not by its lighting units but by other units. In system 100, for example, a non-lighting unit such as power supply unit 132 may fail before LEDs 136. For instance, the LEDs may normally last around 100,000 hours, while the power supply unit 132 may in average fail after about 50,000 hours of usage. Thus, the normal lifetime of system 100 may be determined to be 50,000 hours; that is, the system has to be replaced after the failure of power supply unit 132, while the more expensive parts, i.e., the LEDs, are still usable. Inclusion of such short lifetime, non-lighting units may therefore result in economic or environmental waste. In some embodiments, these problems can be avoided and a lighting system can achieve a higher lifetime by operating without the short lifetime, non-lighting units.

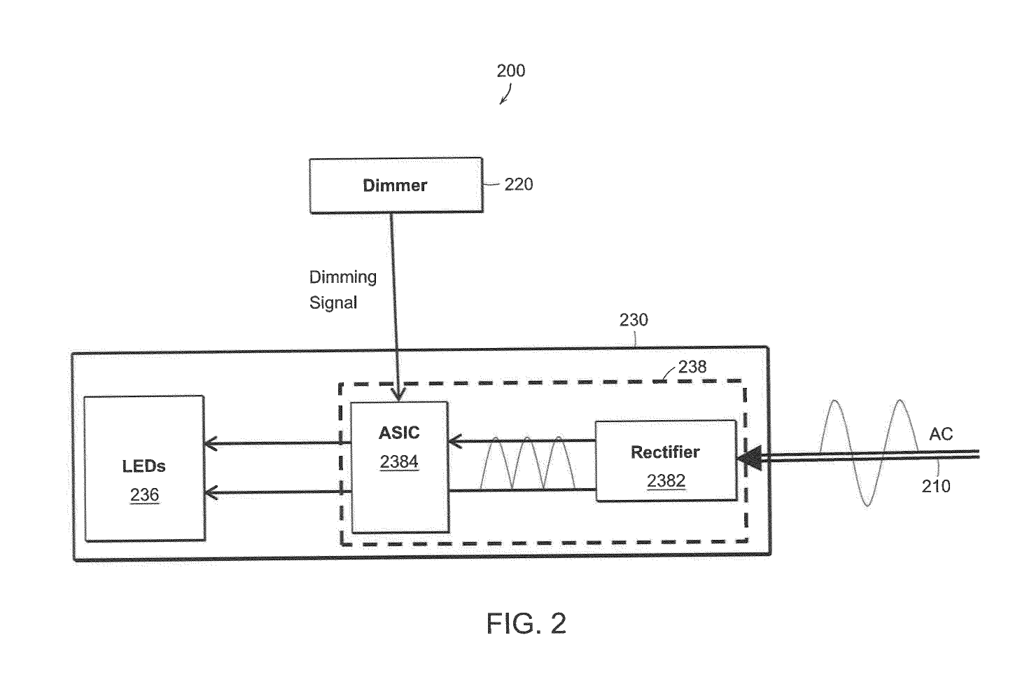

FIG. 2 is a block diagram of such a lighting system 200 using an application-specific integrated circuit (ASIC) according to some embodiments. System 200 includes an AC power line 210, a dimmer 220, and an LED assembly 230. LED assembly 230 includes one or more LEDs 236 and a waveform manipulator module 238. Further, waveform manipulator module 238 includes a rectifier 2382 and an ASIC module 2384.

In some embodiments, dimmer 220 delivers dimming signals to LED assembly 230. In various embodiments, the dimming signals may be in one or more different forms or based on one or more different standards, such as an analog signal, a 0-10 volt signal, a DMX signal, a

Digital Addressable Lighting Interface (DALI) signal, or a powerline signal. In alternative embodiments, the dimming signals may be in one or more different forms or based on one or more different standards, such as a global dimming signal having a voltage varied between 0-10 volts, a Bluetooth signal, a Bluetooth Low Energy signal, a WIFI signal, a Zigbee signal, and a visible light signal (having a wavelength of about 400-700 nm), or any other signal for dimming a light.

The Bluetooth signal may be a data signal exchangeable over a short distance with a wavelength of about 2.4-2.5 GHz. The Bluetooth Low Energy signal may be a data signal exchangeable over a short distance with a wavelength of about 2.4-2.5 GHz and with reduced power consumption. The WIFI signal may be wireless signal in computer networking using 2.4 GHz UHF and/or 5 GHz SHF ISM radio bands, following IEEE 802.11 standards. The Zigbee signal may be a low-cost and low-power wireless signal operable in the industrial, scientific and medical (ISM) radio bands, e.g., 2.4 GHz, 784 MHz, 868 MHz, and 915 MHz, with data rates varying from 20 kbit/s (868 MHz band) to 250 kbit/s (2.4 GHz band).

In some embodiments, LEDs 236 are located on an LED board. In some embodiments, LEDs 236 are divided into two or more subsets, such as two or more LED banks, respectively disposed on a different LED board.

In system 200, waveform manipulator module 238 receives the AC input and the dimming signal. Module 238 delivers voltage and current to LEDs 236, in a manner as further detailed below. System 200 having the waveform manipulator 238 operates without a traditional power supply. In various embodiments, rectifier 2382 generates a rectified voltage and delivers that rectified voltage to ASIC 2384 and/or LEDs 236. Further, based on the value of the voltage at each time, the ASIC may turn on a number of the LEDs that can be turned on by that rectified voltage. In some embodiments the waveform manipulator 238 sends a pulsating voltage at any time to a subset of the LEDs. In some embodiments, waveform manipulator module 238 has a normal lifetime that exceeds those of LEDs 236. Thus, system 200 can achieve a lifetime that is at least around or equivalent to the lifetime of LEDs 236. In some embodiments in which LEDs 236 last around 100,000 hours, for example, the lifetime of system 200 is also around or greater than 100,000 hours.

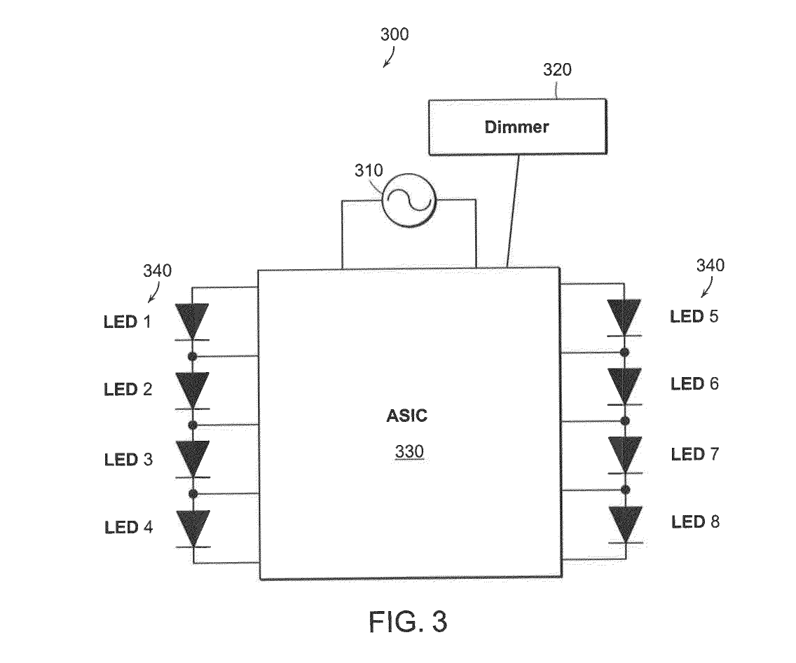

FIG. 3 is a block diagram of a lighting system 300 using an AC step-drive circuit with an ASIC according to some embodiments. System 300 includes an AC power source 310, a dimmer 320, an ASIC 330, and eight LED lights 340, labeled LED 1 to LED 8. AC power source 310 provides an AC power to ASIC 330. In different embodiments, this AC power input can have any suitable effective AC voltages, such as 100, 120, 240, or 277 AC volts, and may have any suitable wave forms, such as a sine wave or a rectified sine wave. ASIC 330 may receive the AC input from power source 310 and a dimming signal from dimmer 320. ASIC 330 then delivers voltages and currents to LEDs 340. In some embodiments, based on the amplitude of the input voltage at any moment, ASIC 330 connects different LEDs in series or in parallel, and determines the currents delivered to different LEDs. In some embodiments, for example, different LEDs are grouped in different LED banks, and the ASIC can send different inputs to different banks.

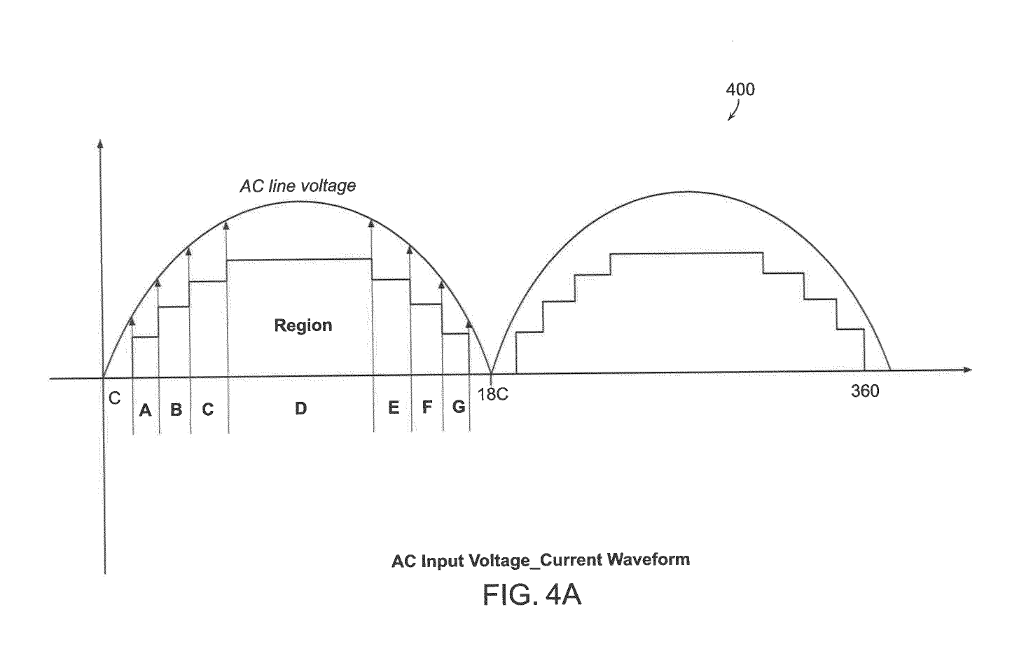

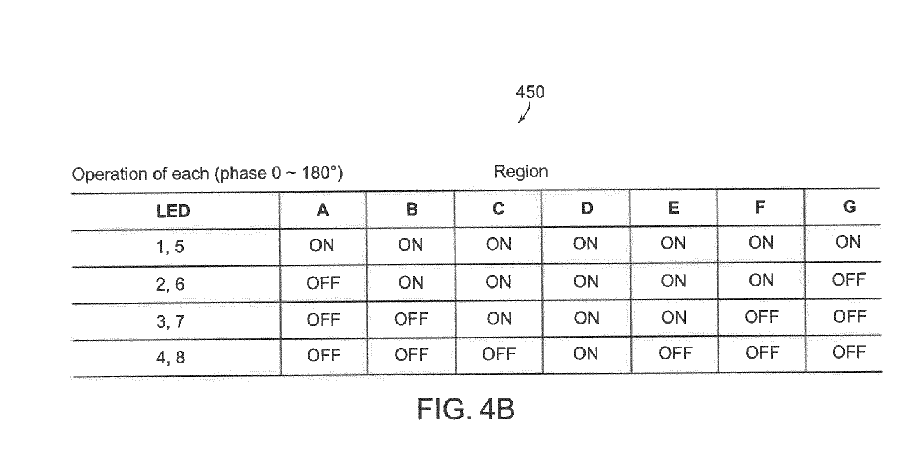

FIGS. 4A and 4B illustrate the basic functionality of LEDs powered directly from a high voltage AC source and controlled by an AC step-drive ASIC, according to some embodiments. In general, depending on the amplitude of the input voltage, for example, the AC step-drive ASIC connects different LEDs in series or in parallel and determines the currents delivered to different LEDs. The basic operation is shown in FIGS. 4A and 4B for one half of a typical AC sine wave. In various embodiments, the AC voltage of the AC source may be 100, 120, 208, 240, or 277 volts. In some embodiments, the ASIC reads the AC input voltage at different times and accordingly turns on one or more LEDs.

In particular, FIG. 4A shows an input waveform 400, which is a rectified sine wave, and FIG. 4B shows an operation table 450. The input waveform 400 may be generated by power source 310 of system 300 in FIG. 3, or by rectifier 2382 of system 200 in FIG. 2.

For example, the LEDs 340 in FIG. 3 may be grouped in four banks, each including two LEDs. That is, the four LED banks may include, respectively, LEDs 1 and 5 (LED bank 1); 2 and 6 (LED bank 2); 3 and 7 (LED bank 3); and 4 and 8 (LED bank 4). ASIC 330 be configured to direct the input voltage to one or more LED banks based on the input voltage of power source 310 transmitted to ASIC 330. In other embodiments, an LED bank may include one, two, or more LEDs.

Waveform 400 shows a full cycle of the rectified voltage output of power source 330 of FIG. 3 or rectifier 2382 of FIG. 2, and depicts the voltage and current output from ASIC 330 to the LEDs 1-8. Table 450 shows the sequence in which the ASIC 330 turns each LED on or off during the first half cycle shown in waveform 400. In particular, FIGS. 4A and 4B show that the ASIC 330 divides each half cycle into seven regions A to G, based on the input voltages. The input voltages sequentially increase in consecutive regions A, B, C, and D, and sequentially decrease in consecutive regions D, E, F, and G. Regions A and G have the lowest voltage, while region D has the highest voltage.

Based on the input voltage in each region, ASIC 330 may turn on or off different LED banks. Table 450 of FIG. 4B shows which LED banks ASIC 330 turns on or off in each region of the half cycle. More specifically, at the start of the first half cycle, when the input voltage is zero, ASIC 330 turns off all LEDs. In this first half cycle, as the voltage increases from region A to D, ASIC 330 consecutively turns on the LED banks 1 to 4. In particular, ASIC 330 turns on LEDs 1 and 5 in region A, turns on LEDs 2 and 6 in region B, turns on LEDs 3 and 7 in C, and turns on LEDs 4 and 8 in region D. In one embodiment, after an LED bank is turned on, it will remain as turned-on until it is turned off again in another region of the waveform 400.

As the voltage decreases beyond region D, ASIC 330 turns off the LED banks in the reverse order, starting from fourth bank. That is, ASIC 330 turns off LEDs 4 and 8 in region E, turns off LEDs 3 and 7 in region F, turns off LEDs 2 and 6 in region G, and turns off LEDs 1 and 5 after region G. ASIC 330 acts similarly in the second half cycle of each full cycle of the rectified voltage.

Thus, as seen in table 450, the first LED bank (LEDs 1 and 5) is on in all regions A to G, the second bank (LEDs 2 and 6) is on in regions B to F, the third LED bank (LEDs 3 and 7) is on in regions C to E, and the fourth LED bank (LEDs 4 and 8) is on only in region D. In other words, in regions A and G only LEDs 1 and 5 are on, and all other LED banks are off. Conversely, in region D all eight LEDs 1-8 are on. In each region, turning on and off of the LED banks, and their currents are controlled by ASIC 330 based on AC line voltage.

Based on this exemplary sequence of turning the LED banks on and off, ASIC 330 can control the output characteristics of the light system, such as its luminosity, color, color temperature, or dimming profile, as further detailed below. ASIC 330 may do so, for example, if different LED banks have different input voltages or different light characteristics, such as color or color temperature. The ASIC may also determine the percentage by which each LED bank contributes to the overall light output by determining at what percentage of the time that bank is on. This contribution may also depend on the total number of LEDs or the forward voltage (V_{f}) for each bank. In one embodiment, for example, LEDs 1 and 5 may have a V_{f} of 36 volts, which corresponds to the voltage in regions A and G. LEDs 2 and 6, on the other hand, may have a V_{f} of 18 volts, such that the step voltages for regions B and F are around 54 (36 plus 18). Further, LEDs 3 and 7 may have a V_{f} of 3 volts and the step voltages of regions C and E may be around 57 volts (54+3). And LEDs 4 and 8 may have a V_{f} of 18 volts and the step voltage of region D may be around 85 volts (57+18).

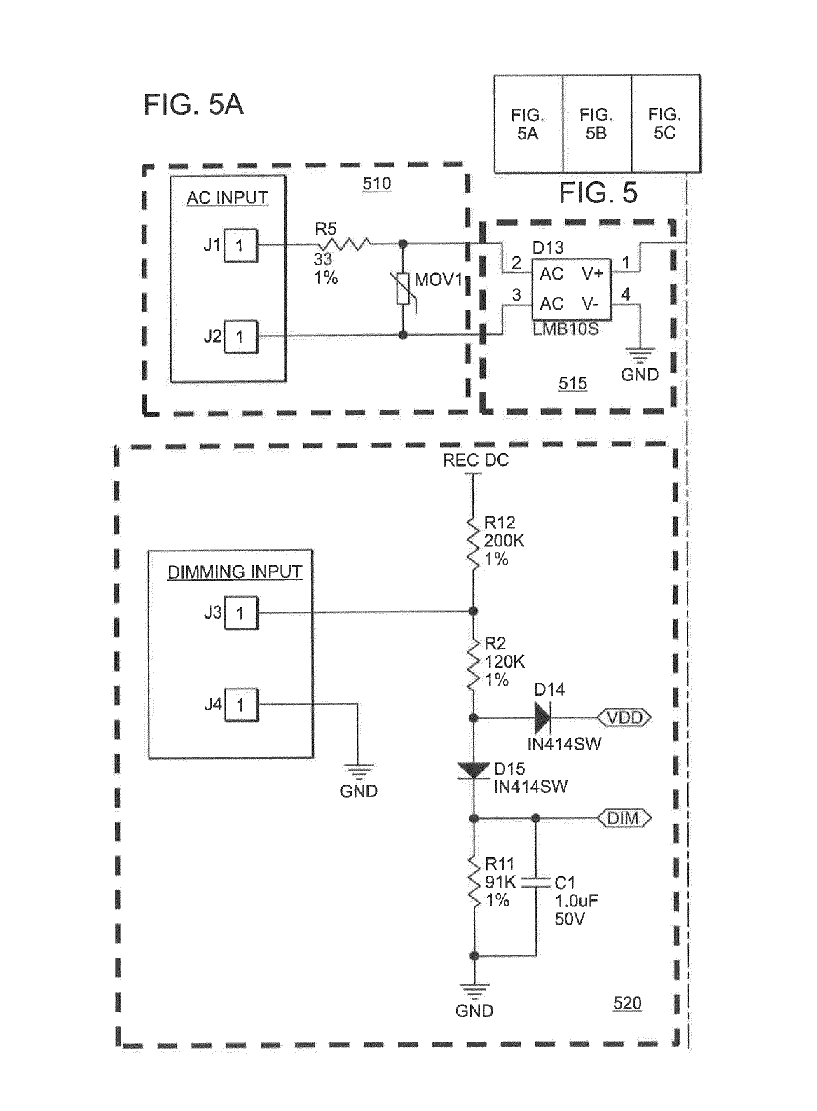

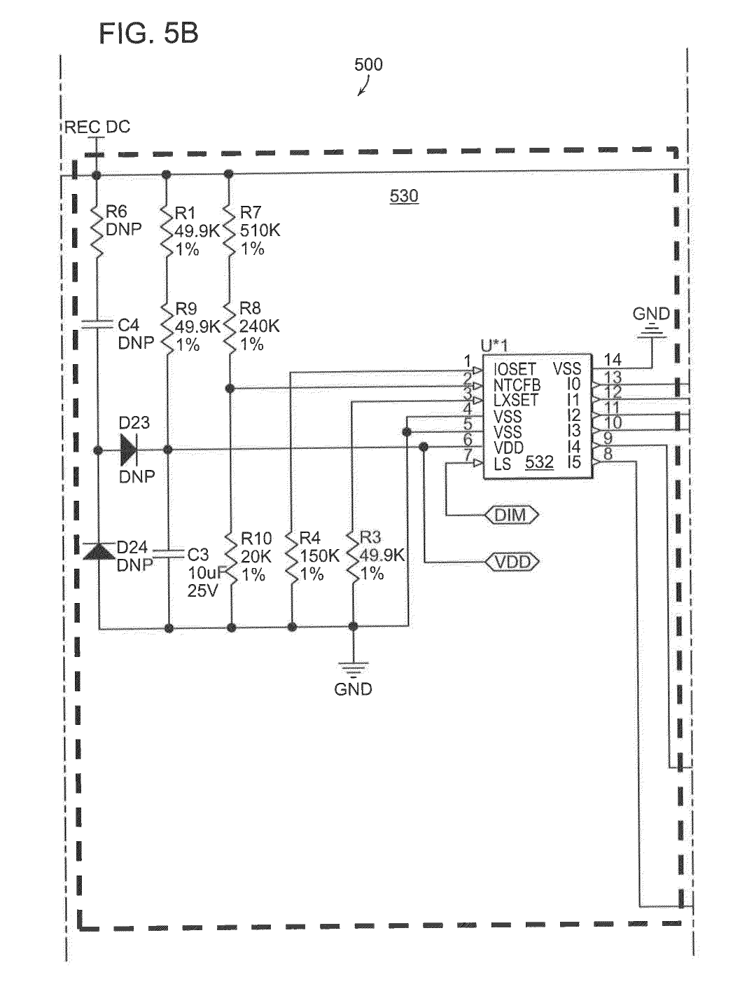

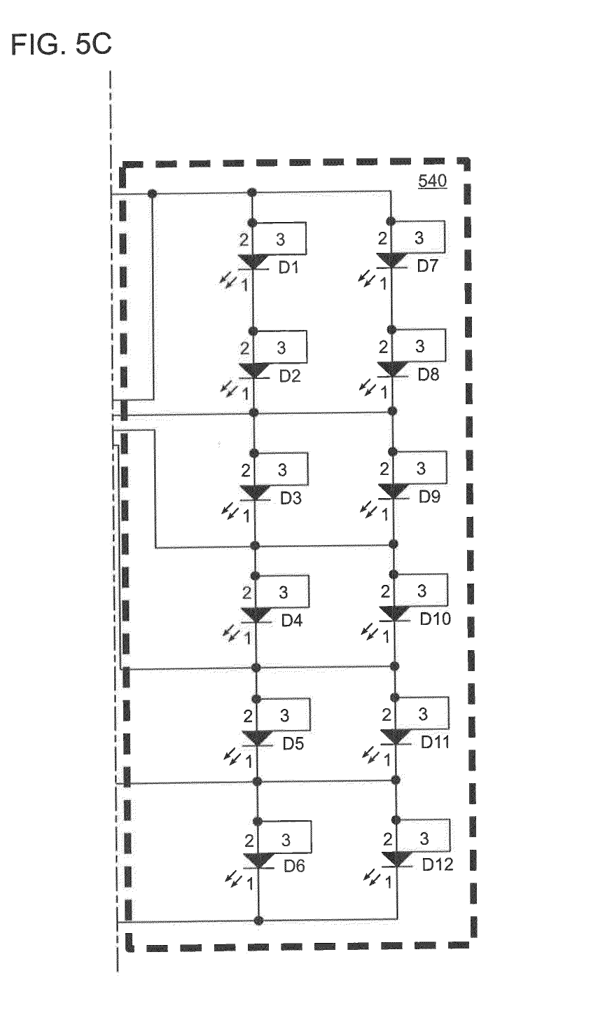

FIGS. 5A-5C include a schematic of a lighting system 500 according to some embodiments. System 500 includes a power input module 510, a rectifier 515, a dimmer module 520, an ASIC module 530, and a light section 540.

Power input module 510 includes input terminals J1-J2, a resistor R5 and a variable resistor (or varistor) MOV1. Terminals J1-J2 are the input terminals through which an AC input voltage (from, for example, a wall power outlet) is applied to the system. In various embodiments, the AC voltage of the AC input may be 100, 120, 208, 240, or 277 AC volts or any other know voltage. Resistor R5 and varistor MOV1 protect the circuit from over current and lighting surges. Rectifier D13 rectifies the AC voltage into pulsating DC voltage.

Dimmer module 520 includes input terminals J3-J4, capacitor C1, diodes D14 and D15, and resistors R2, R11, and R12. Terminals J3-J4 are the input terminals for receiving dimming input (or dimming signals). Resisters R12, R2, and R11 serve as a voltage divider, and terminal J3 is connected to a terminal (e.g., LS) of ASIC 532 through the voltage divider. Terminal J4 is grounded. In some embodiments, a dimmer input is a DC voltage. A dimmer input of 10 Vdc, for example, may indicate a full on and a dimmer input of 0 Vdc may indicate an off. In some embodiments, the dimmer input is a digital signal. This digital signal may include signals based on common industry protocols, such as DALI, DMX, RDM, digital power line communication, or any other diming protocol.

ASIC module 530 includes resistors R1, R3, R4, and R7-R10; capacitor C3, and ASIC 532. ASIC module 530 may additional include resister R6, capacitor C4, and diodes 23 and 24. Elements C3, R1, and R9 filter the rectified voltage and provide power to a terminal (e.g., VDD) of ASIC 532. Elements R7, R8, and R10 provide a reference voltage to a terminal (e.g., NTCFB) of ASIC 532 that is relative to the rectified AC input. In some embodiments, element R3 sets the LEDs operating current via a switch, through a terminal (e.g., IVSET) of ASIC 532.

In this embodiment, light section 540 includes twelve LEDs D1-D12. These LEDs are grouped into five banks. The first bank includes four LEDs D1, D3, D7, and D8. The second to fifth banks each include two LEDs. The second bank, for example, includes LEDs D3 and D9, the third bank includes LEDs D4 and D10, the fourth bank includes LEDs D5 and D11, and the fifth bank includes LEDs D6 and D12. Based on the forward voltage, ASIC module 530 may connect one or more of these banks to terminals I0, I1, I2, I3, I4, and I5 of ASIC 532.

In some embodiments, the LEDs in system 500 have a forward voltage (Vf) of about 21V and have the same color output. In some other embodiments, different LEDs have different forward voltages. Such a variation in forward voltages may allow the LED string to turn on at a lower AC input voltage.

Moreover, in some embodiments, different LEDs may also have different colors or color temperatures. In one embodiment, for example, the LEDs include a combination of amber LEDs and white LEDs. Some such embodiments may be configured such that when the system is dimmed, the color shifts to warmer or cooler color temperatures, or dim to other color points. Such a shift may be tuned to mimic the behavior of a traditional incandescent bulb.

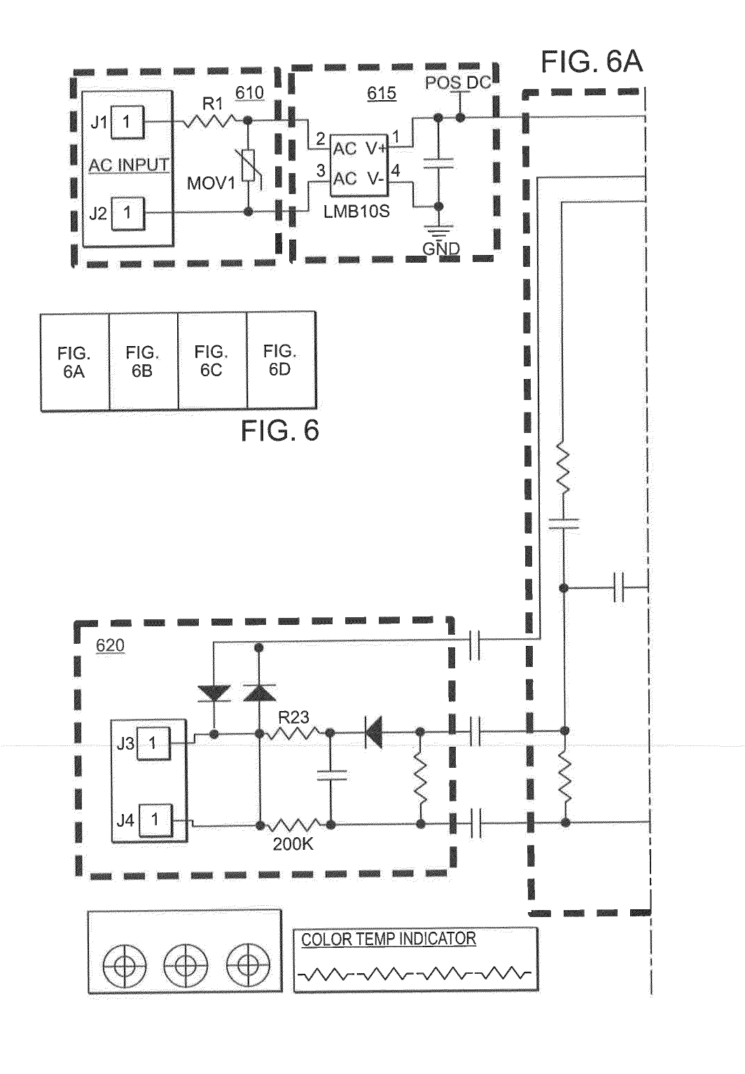

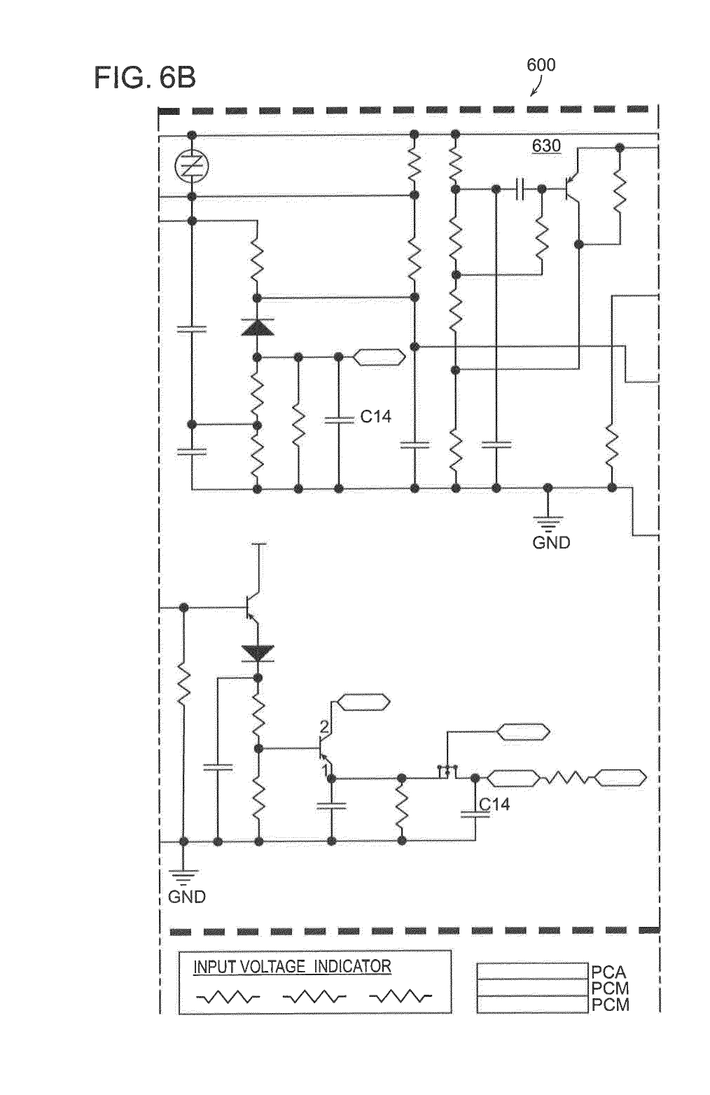

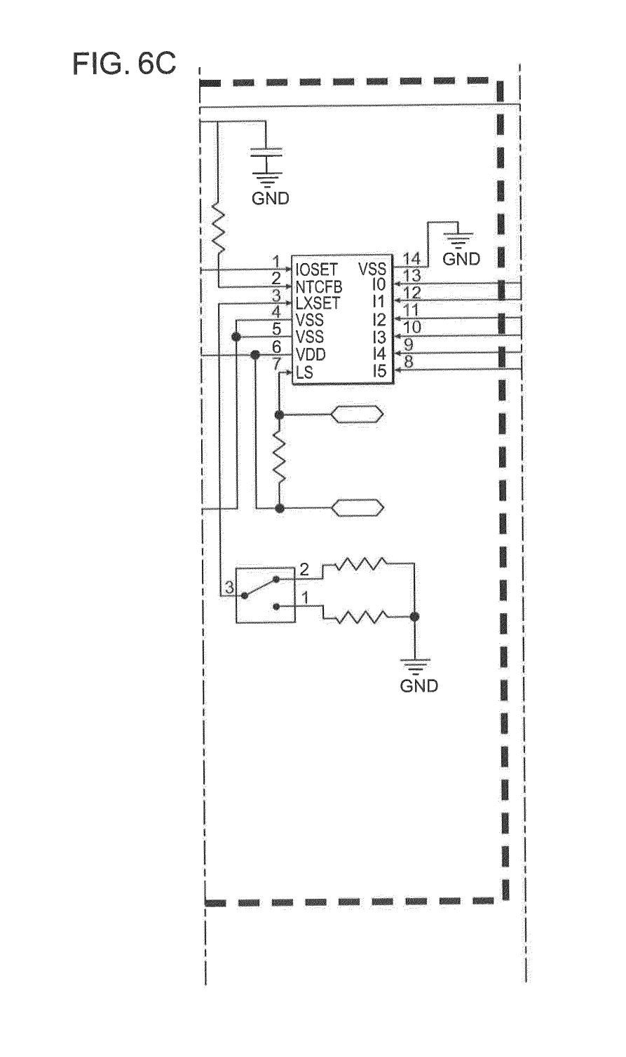

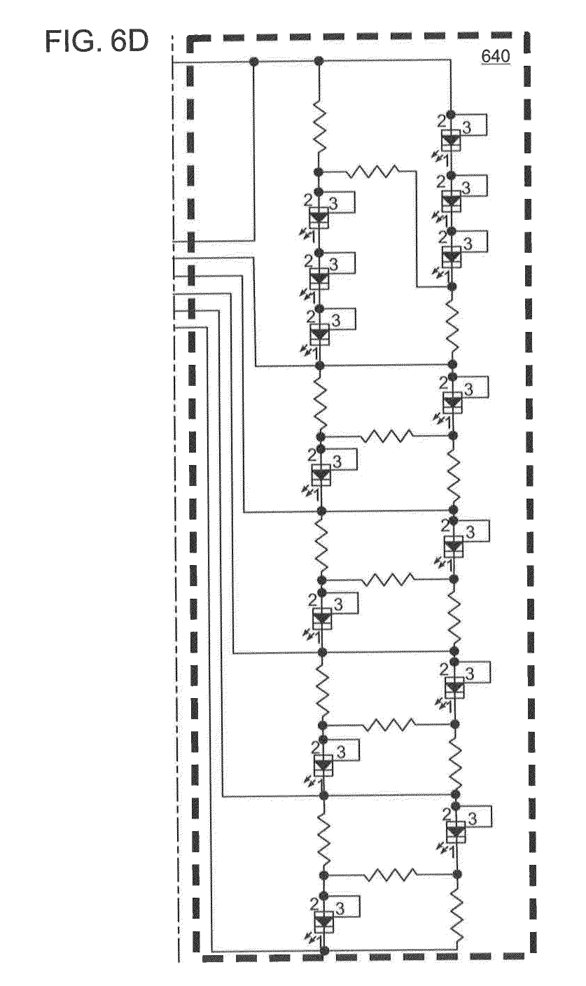

In some embodiments, the lighting system can operate with different input voltages, such as commercial and industrial voltages. FIGS. 6A-6D include a schematic of a lighting system 600 according to one such embodiment. System 600 includes a power input module 610, a rectifier 615, a dimmer module 620, an ASIC module 630, and a light section 640.

In system 600, dimmer module 620 is electrically isolated from possible surges in the remainder of the system by one or more of capacitors C2, C13, and C14. In some embodiments such protections is provided via Zener diodes or some opto-isolators such as PC817 or any other protection device.

Light section 640, includes fourteen LEDs D1-D14 grouped into five banks. Section 640, however, also includes fifteen switch resistors R13-R27. These switches open or close to form different serial configurations based on the input voltage to system 600. Based on the input voltage, a user may change the serial configuration by operating the switches, separately or all together. Alternatively, the system may automatically change the states of the switches based on the input voltage. In some embodiments, ASIC module 630 reads in the input voltage and accordingly operates the switches.

For example, when operating with a low voltage (such as a commercial or residential 120 volts/AC), switches R14, R17, R20, R23, and R26 may open while the other switches may close. In such a configuration, LED banks one to five are connected in series. Further, in the first LED bank, for example, the series combination of D1-D3 is connected in parallel with the series combination of D4-D6. Similarly, in the second to fifth banks, respectively, D7 is connected in parallel to D8; D9 is connected in parallel to D10; D11 is connected in parallel to D12; and D13 is connected in parallel to D14.

When operating at a higher input voltage (such as an industrial 270 volts/AC), switches R14, R17, R20, R23, and R26 may close, while the other switches open. In such a configuration, therefore, banks one to five are still connected in series. But, unlike in the lower voltage example, the LEDs in each bank are also all connected in series. That is, the first bank includes a series connection of six LEDs D1-D6. Similarly, the second to fifth banks respectively include series connections of pairs of LEDs D7 and D8, D9 and D10, D11 and D12, and D13 and D14.

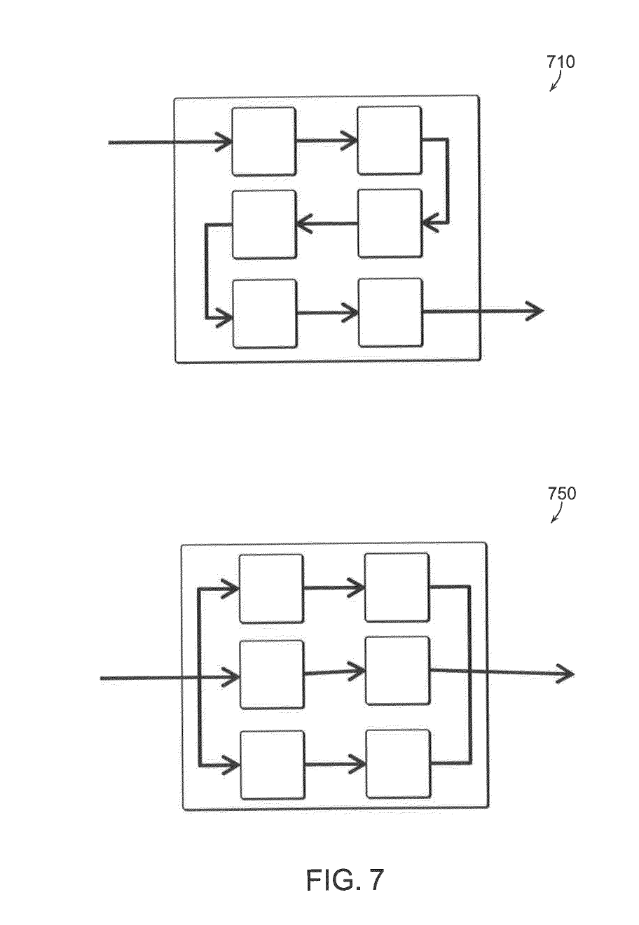

Some embodiments may use LEDs of different input voltages. In some embodiments, the input voltage of an LED may change based on the internal combination of dyes. FIG. 7 depicts structures of two such LEDs 710 and 750 according to some embodiments. LED 710 includes six dyes that are connected in series. LED 750, on the other hand, includes a parallel connection of three pairs of dyes, each pair of dyes connected in series. In some embodiments, each dye has a three volt input. The operating voltage of LED 710, therefore, can be around 18 volts, while that of LED 750 can be around 6 volts. A system may use in some locations the 18 volt LED 710 or connect in series three of the 6 volt LEDs 750.

In various embodiments, a user can utilize the dimmer to modify the visual characteristics of the light output. The user may, for example, set the dimmer to a low, medium, or high level. The dimmer, in turn, may cause the lighting system to set a characteristic of the output light at a corresponding level. The characteristic of the light may, for example, be its intensity, color, temperature, or a combination of these characteristics.

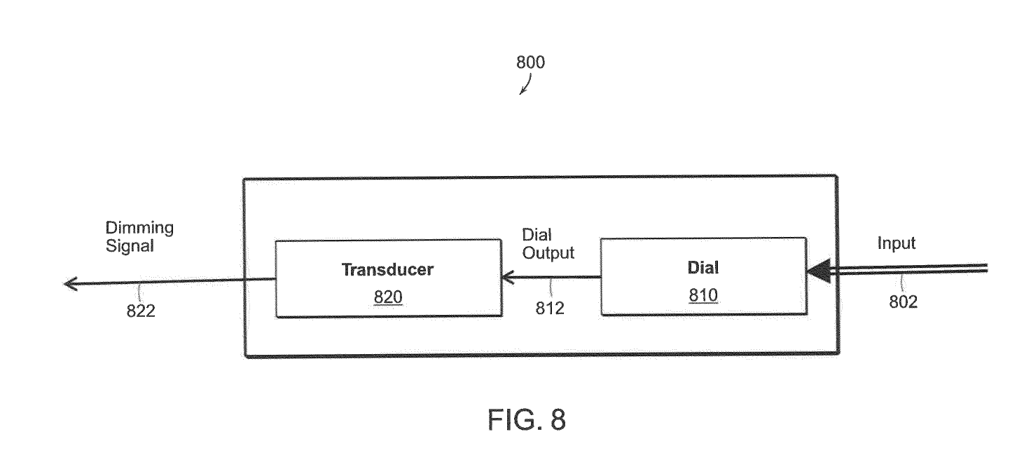

FIG. 8 is a schematic of a dimmer mechanism 800 according to some embodiments. Dimmer 800 includes a dimming dial 810 and a transducer 820. In some embodiments, dimming dial 810 is a dimmer user interface and transducer 820 is a dimmer communication device. Transducer 820 may be an analog or a digital transducer.

Dimming dial 810 is configured to receive an input 802 and generate, based on the input, a dial output 812. Dimming dial 810 may be a mechanical dial, such as a linear multi-level dial or a circular turning dial. Input 802 may be a mechanical input from a user who sets the dial at a desired level, e.g., low, medium, or high. Dimming dial 810 may alternatively be another type of dial, such as a digital or visual dial. A user may, for example, set the dial via a display screen or a touch screen.

Based on the dial's setting, dial 810 generates dial output 812. In some embodiments, dial output 812 is a DC voltage. In a 0-10 volt DC dial, for example, dial output 812 is a DC voltage between 0 and 10 volts, which is proportional to the input. For example, when the input is at very low dim, dial output 812 may be very close or equal to 0 volts. Similarly, at mid and high dim levels, dial output 812 may be around 5 and 10 volts, respectively. Dial output 812 may also be a digital signal.

Transducer 820 receives dial output 812 and transforms it into dimming signal 822.

Dimming signal 822 may, for example, determine a quantitative characteristic of the light output, such as its intensity or temperature. Dimming signal 822 may alternatively determine a qualitative characteristic of the output light, such as its color or color combination. Dimming signal 822 may also determine a combination of two or more characteristics, which may be quantitative, qualitative, or both. In various embodiments, dial output 812 or dimming signal 822 may be in one or more different forms or based on one or more different standards, such as an analog signal, a 0-10 volt signal, a DMX signal, a DALI signal, a powerline signal, or any other known signal.

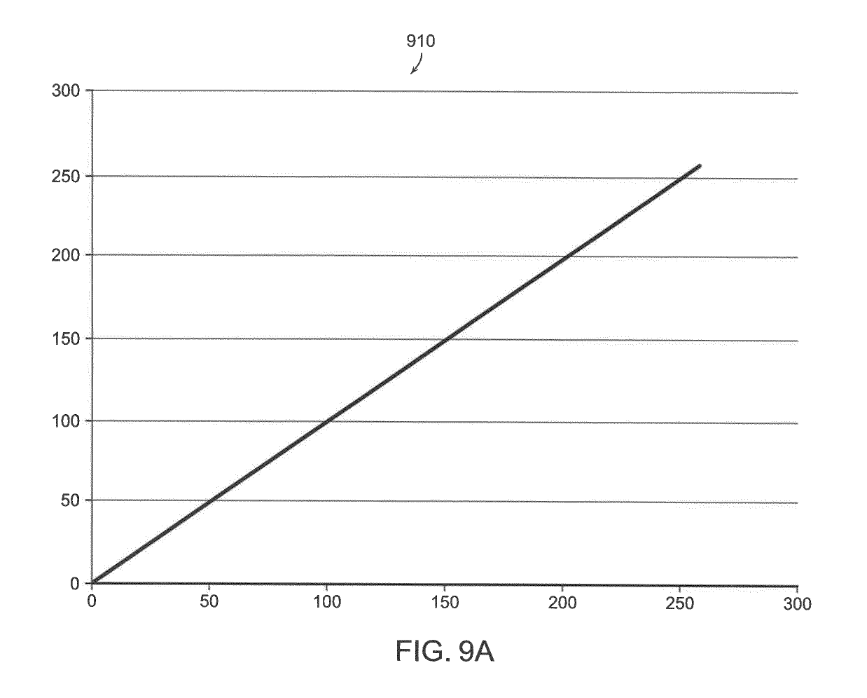

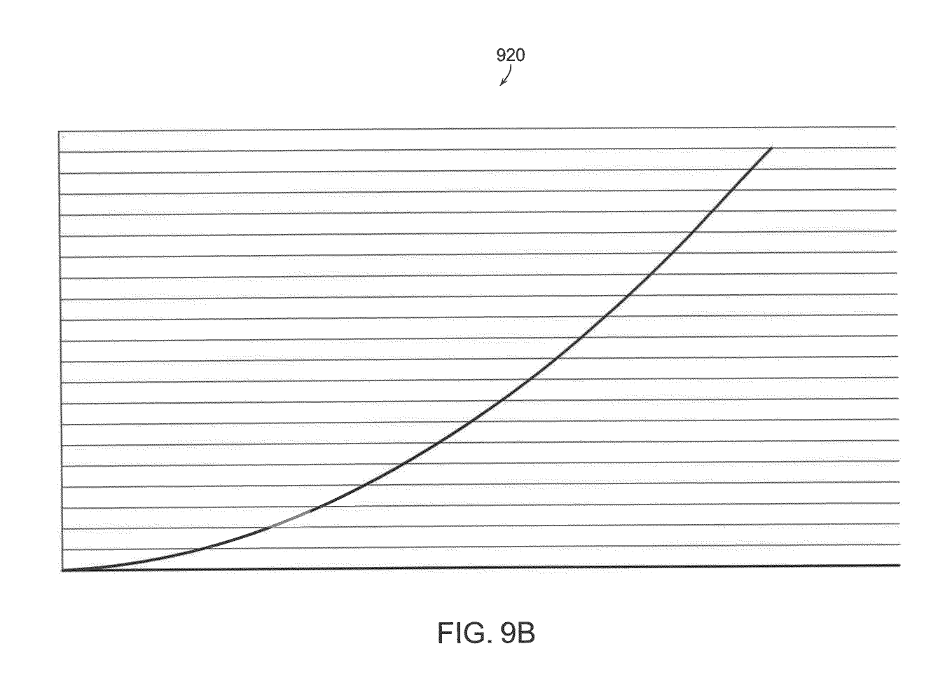

Different dimmers may depict different dimming styles. The dimming style may determine one or both of two relationships, which are the relationship between dimming signal 822 and input 802, and the relationship between dimming signal 822 and dial output 812. The dimming style may also relate to a relationship between the dimming signal and the output of the ASIC to the LEDs. FIGS. 9A and 9B illustrate two different forms of such relationships according to various embodiments. FIG. 9A shows a schematic of a linear relationship via linear graph 910. FIG. 9B, on the other hand, shows a schematic of a non-linear relationship via a non-linear graph 920. In graphs 910 and 920, abscissas stand for a quantitative measurement of the input or the dial output in some arbitrary units, and ordinates stand for a value of a quantitative characteristic, such as color temperature or intensity, also in arbitrary units.

In graph 910, the relationship between the input and the output is linear. In other words, the output changes proportional to the input. In non-linear graph 920, on the other hand, the relationship is logarithmic, that is, the output changes proportional to a logarithm of the input.

Various embodiments may use a dimmer with a style that is linear (such as that shown in FIG. 9A) or non-linear, e.g., logarithmic (such as that shown in FIG. 9B). In general, the human eye may perceive the sensory changes logarithmically. That is, when the dimmer reduces a quantitative characteristic by 25%, the human eye may perceive around 50% reduction in the output. Some embodiments may compensate for this perception phenomenon by using a style that is non-linear, e.g., logarithmic or exponential.

The dimming style may be set through transducer 820 of FIG. 8. In some embodiments, transducer 820 is designed to use a linear or a non-linear style. In some embodiments, the transducer's hardware design enables it to use one or more types of styles. In some embodiments, transducer 820 can be programmed, via software such as firmware, to use one or more types of styles. In some embodiments, dimmer 800 of FIG. 8 includes a memory that stores information related to different dimming style, and transducer 820 uses that information to set the dimming style. In some embodiments, transducer 820 implements one or another dimming style by using a lookup table, for converting dial output 812 of FIG. 8 to dimming signal 822 of FIG. 8. In some embodiments, different dimming styles are stored in the light fixture or in the ASIC. A light controller may then select one of the dimming styles for the operation of the lighting system at a specific time.

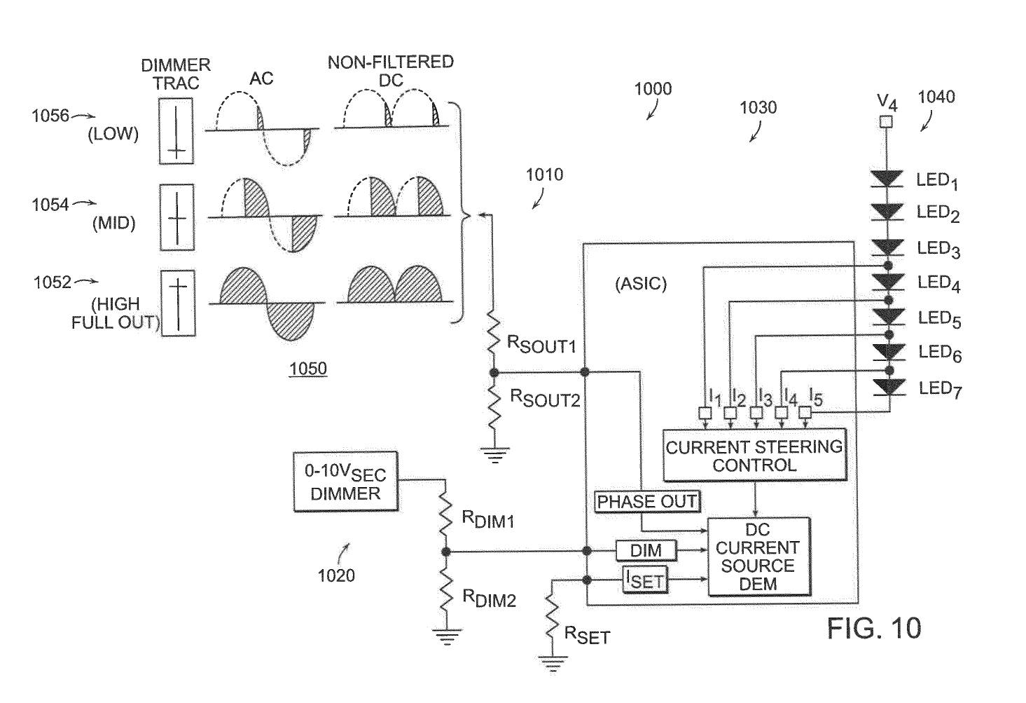

In various embodiments, an ASIC receives an input waveform that is modified by dimmer 800 of FIG. 8 and accordingly changes the input current or voltage to the LEDs. FIG. 10 shows a schematic of a lighting system 1000 and its dimming mechanism according to one such embodiment. System 1000 includes a power input module 1010, a dimmer module 1020, an ASIC module 1030, and a light section 1040.

Dimmer 1020 may affect the waveform of the AC input to ASIC 1030. System 1000, for example, uses a TRIAC dimming mechanism. FIG. 10 also shows a waveform section 1050 depicting three different dimming levels, and the corresponding AC waveforms and rectified waveforms according to an embodiment. In particular, when dimmer 1020 is at the highest level 1052, indicating no dimming, the waveform has a full form. When dimmer 1020 is at the mid-level, indicating half dimming, half of the waveform is truncated. Finally, when dimmer 1020 is at the low level, indicating a “low dim”, most of the waveform is truncated. At each dimming level, ASIC 1030 receives the corresponding waveform and based on that waveform adjusts the voltage or the current sent to different LED banks.

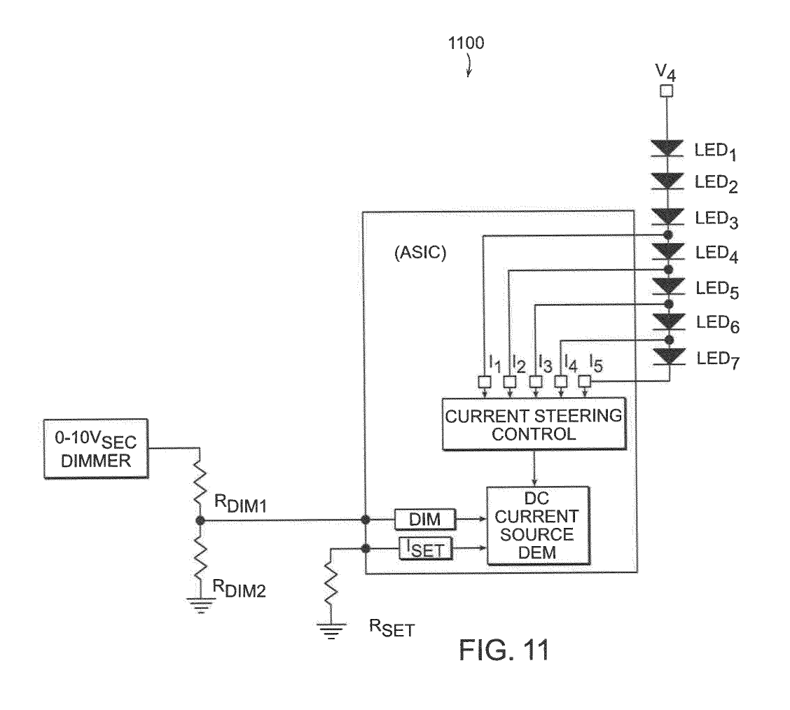

FIG. 11 shows a schematic of a lighting system 1100 and its dimming mechanism according to another embodiment. In FIG. 11, the dimmer is a 0-10 volt type dimmer.

In some embodiments, the lighting system can control the color rendering index (CRI) of the light output. In various embodiments, the CRI of a light source compares the ability of the light source with an ideal or a natural light source in reproducing the colors of illuminated objects. The CRI of a light source may be measured in a scale of 0 to 100, where the most accurate rendition index of 100 corresponds to a black body radiation light source. In some applications of light sources, such as in museums, exhibitions, or libraries, the accuracy of color rendition may be important. Such applications may thus require a lighting system with a high CRI, e.g., above 85 or 90. Some other applications, such as outdoor lights, may not need a high color rendering accuracy. These applications may be able to use less expensive, such as fluorescent, light systems, which have a lower CRI, e.g., between 60 and 80. In some embodiments, such as those discussed below, a lighting system can provide light outputs with different CRIs. The output can thus be adjusted to the desirable CRI. In some embodiments, for example, the CRI may increase by an increase in a red component of the light. The light output per power input, on the other hand, may increase by an increase in a blue component; such increase in the blue component, however, may lower the CRI.

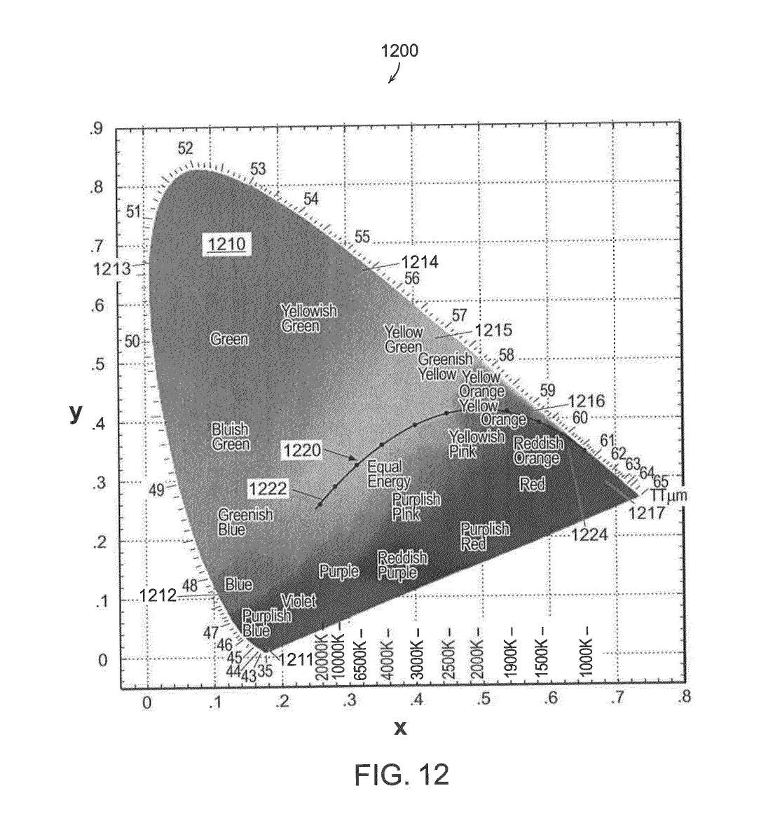

In some embodiments, the lighting system can control the color output and its temperature at different dimming levels. These outputs can be traced in various multi-dimensional diagrams of color output. FIG. 12 depicts a CIE 1931 chromaticity diagram 1200.

The diagram uses a two dimensional x-y space, where x and y may be functions of one or more of the color stimuli (such as red, green, or blue stimuli) or their brightness. In the diagram, the area 1210 may represent the space of all visible colors. The boundary of area 1210 may continuously span the mono-chromatic spectrum from one end to the other. For example, areas 1211-1217 may respectively correspond to purple, blue, green, yellowish green, yellow, orange, and red. Diagram 1200 further depicts diming trace 1220 of a black body light source. At its brightest, this light source has a color around point 1222, which is almost white. As the light source dims, its color spectrum moves towards the red end at point 1224.

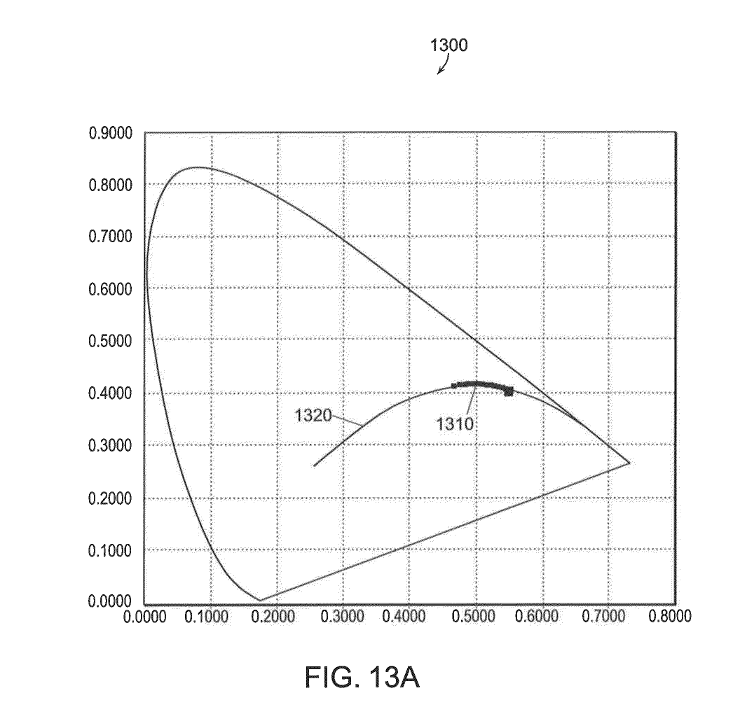

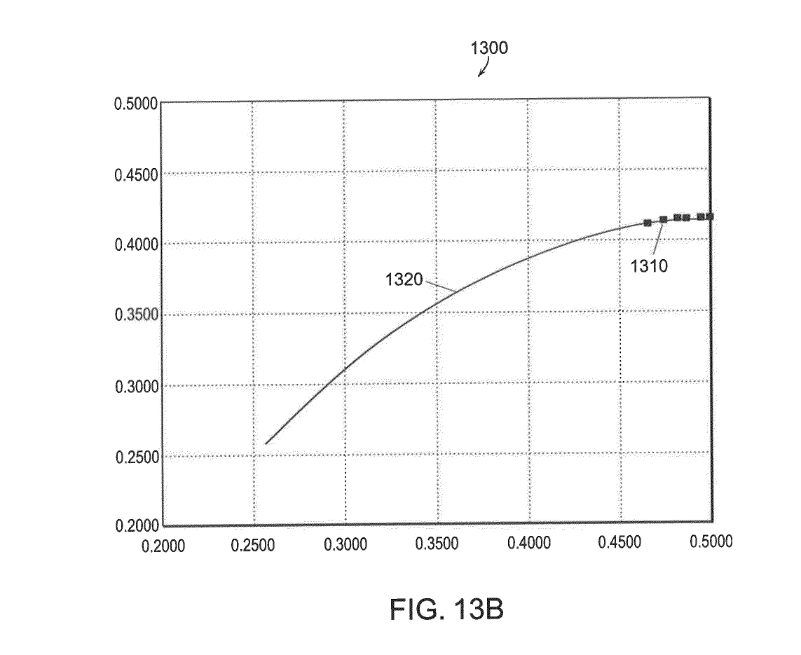

In some embodiments, an LED based lighting system can provide a color and dimming profile that is similar to those of an incandescent light. Such systems can thus be added to a location which also uses incandescent lights, without generating an inhomogeneous color perception. A dimming profile relates to the change in one or more characteristics of the light output as the dimming input changes. FIGS. 13A and 13B show the measured dimming profile 1310 of an incandescent light source in a CIE diagram 1300. Diagram 1300 also shows dimming trace 1320 of a black body light source for comparison. FIG. 13B shows the measure data section of FIG. 13A, magnified for clarity of its details. Points 1310 show the measured values of the color generated by an incandescent light as it dims. In particular, as the incandescent light dims, the measured color moves from left to right, towards the red spectrum.

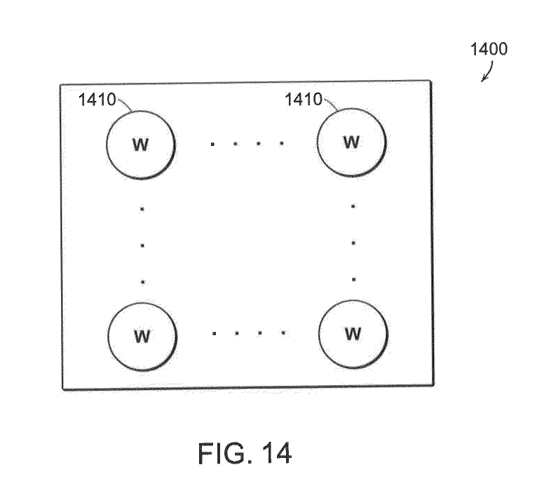

Some embodiments utilize white color LEDs that mimic the black body radiation in some ranges. FIG. 14 shows a white LED board 1400 according to one such embodiment. LED board 1400 includes one or more LEDs 1410. In one embodiment, each LED 1410 is a 3000K white LED.

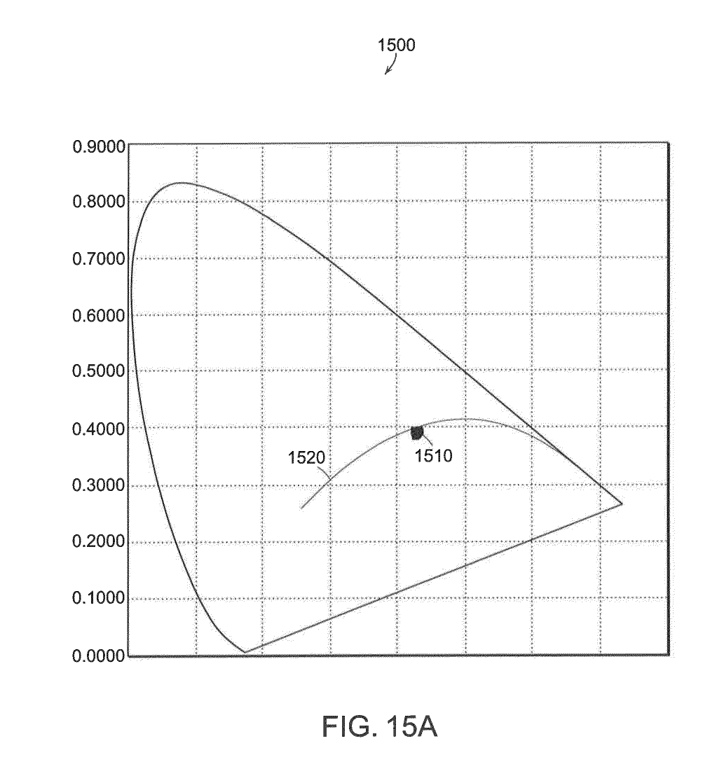

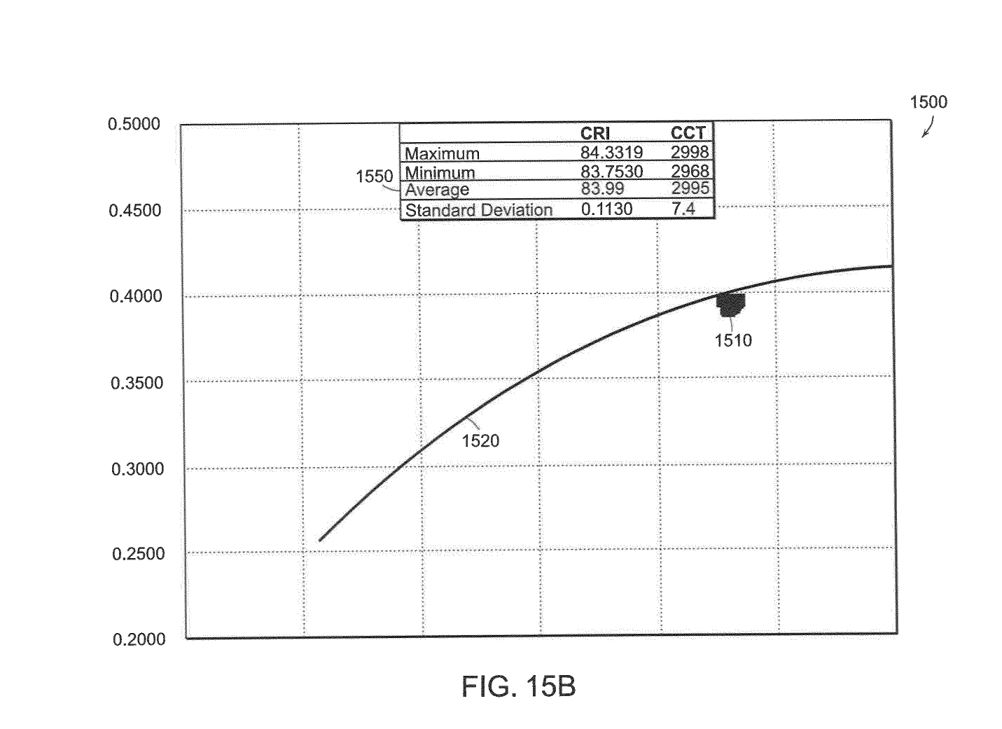

FIGS. 15A and 15B show the measured dimming profile 1510 of a white LED light source in a CIE diagram 1500. The white LED light source may utilize a white LED board such as LED board 1400 of FIG. 14. Diagram 1500 also shows dimming trace 1520 of a black body light source for comparison. FIG. 15B shows the measured data section of FIG. 15A, magnified for clarity of its details. FIG. 15B also includes a data table 1550, summarizing the measured data.

Data points 1510 show the measured values of the colors generated by the white LED light source as it dims. These data points include multiple points that almost overlap in the CIE diagram 1500. Further, data points 1510 are located near black body dimming trace 1520. Data points 1510 thus indicate that the color output of the white LED light source is similar to that of the black body light source at one specific dimming value. Moreover, as the white light source dims, its color point does not change. Data table 1550 indicates same results. It shows that the CCT, i.e., color temperate, of the white light source changes between 2998 and 2968 as the light dims, indicating only about 1% change in the color temperature. The data also show that the CRI of the white light source remains around 84.

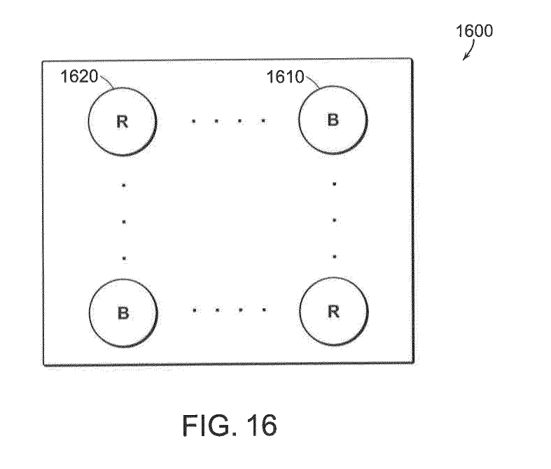

Some embodiments utilize a combination of two or more different color LEDs. FIG. 16 shows a bi-color LED board 1600 according to one such embodiment. LED board 1600 includes multiple LEDs, some of which are blue LEDs 1610 and some are red LEDs 1620. In some embodiments, red LED 1620 generates a light that is mainly in the red region of the spectrum, while blue LED 1610 generates light that is essentially in the blue region. In some embodiments, blue LED 1610 generates a greenish yellow light. In some embodiments, different subsets of the LEDs in the LED board are included in different LED banks. For example, in board 1600, the multiple LEDs may be divided into one or more red LED banks that include red LEDs 1620, and one or more blue banks that include blue LEDs 1610.

In some embodiments that use board 1600, as the dimmer changes the dimming signal, the ASIC can change the luminance of the red or blue LEDs such that the color temperature or other characteristics of the light changes in a desired manner. In some embodiments, the ASIC can implement more than one dimming profile. The ASIC may implement more than one dimming profile for the same system by using different dimming profile programs. In some embodiments, a dimming profile program determines, based on the dimming signal input to the ASIC, the output from the ASIC to different LEDs in the system.

In some embodiments, the ASIC may implement a dimming profile in which dimming the light changes one or more of the color temperature and color point in a pre-determined manner. The ASIC may implement the dimming profile by, for example, determining the sequence and percentage of time each LED bank is on or off.

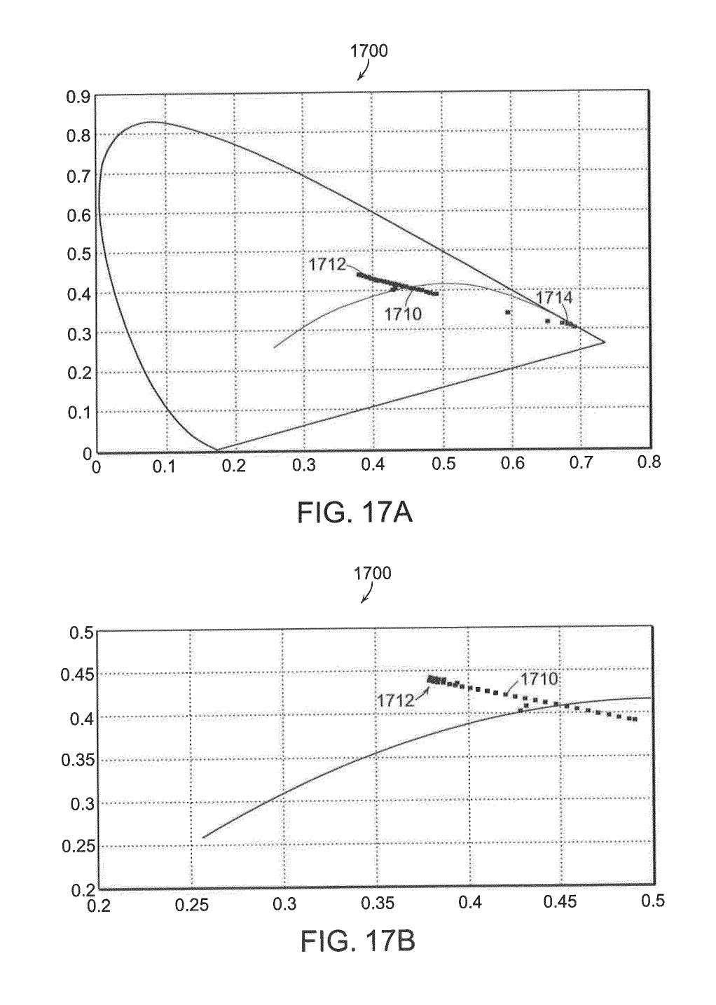

FIGS. 17A and 17B show the measured dimming profile 1710 of a bi-color light source in a CIE diagram 1700 according to one embodiment. The bi-color light source may utilize a bi-color board such as LED board 1600 of FIG. 16. FIG. 17B shows the measured data section of FIG. 17A, magnified for clarity of its details.

Data points in dimming profile 1710 show the measured values of the colors generated by the bi-color light source as it dims. The data points indicate that as the light source dims, the ASIC changes the color output such that it moves from the greenish yellow end 1712 towards the red end 1714. Such a change towards red may mimic for a user the similar dimming change towards red in the incandescent or black body lights.

The ASIC may implement a different dimming profile in which, for example, dimming the light does not change the color temperature. This setup may be used where, for example, the lighting on an object needs to remain the same as the intensity of the ambient light changes.

Such a dimming profile may not be feasible for traditional lighting systems, such as those using incandescent lights, because incandescent lights change temperature as they dim. But some embodiments using ASIC and LEDs can achieve this behavior. Moreover, various embodiments can be configured to change their dimming profile in real time.

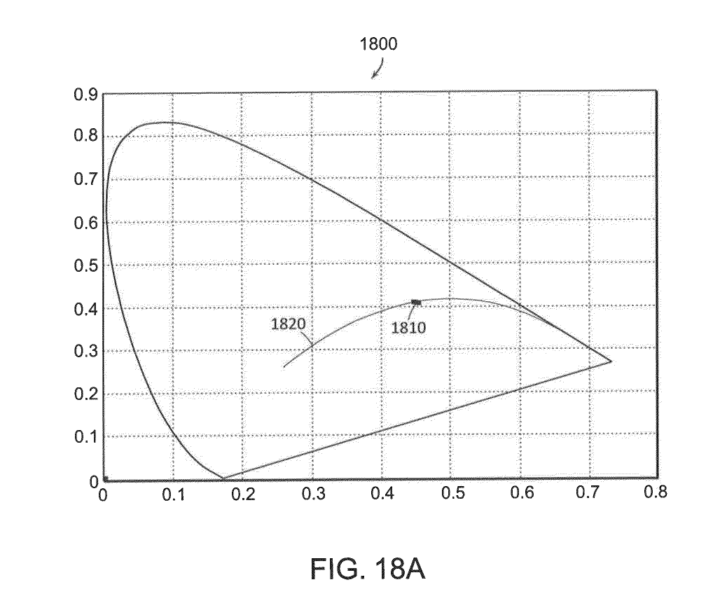

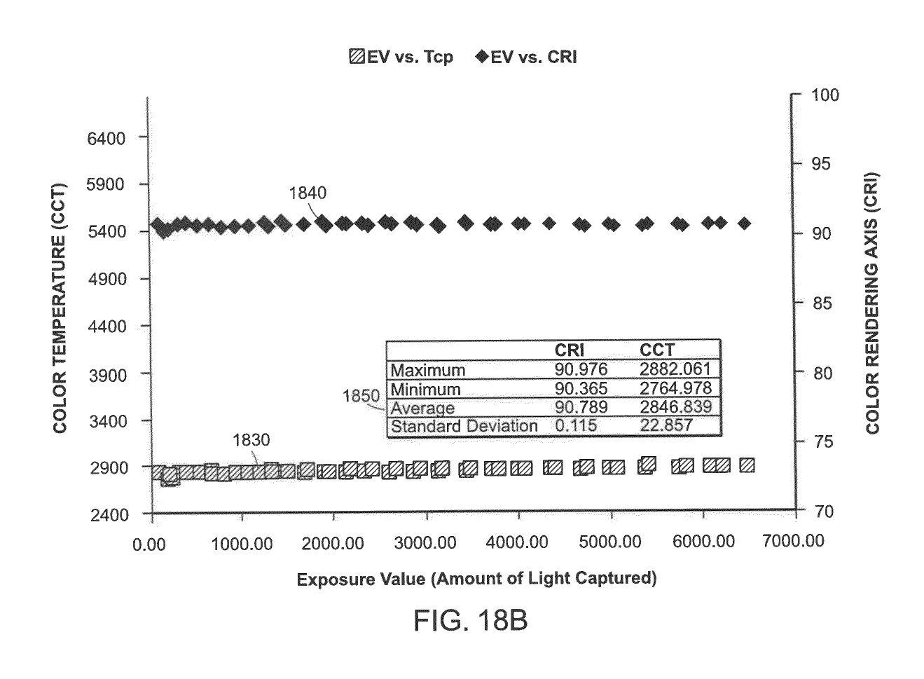

FIG. 18A shows the measured dimming profile 1810 of another bi-color light source in a CIE diagram 1800 according to such an embodiment. The bi-color light source of FIG. 18A, similar to that of FIGS. 17A and 17B, may utilize a bi-color LED board such as LED board 1600 of FIG. 16.

In the embodiment corresponding to FIG. 18A, however, the ASIC uses a dimming profile different from that corresponding to FIGS. 17A and 17B. In particular, data points in profile 1810 almost overlap in the CIE diagram 1800. This indicates that as the light source dims, the ASIC changes the output to the LEDS such that, as the light intensity dims, the color output does not change and remain on the black body radiation trace 1820.

FIG. 18B shows some measurements for dimming profile 1810 of the bi-color light source of FIG. 18A. In particular, FIG. 18B includes color temperature data points 1830 and CRI data points 1840 for the dimming profile data points 1810. FIG. 18B also includes data table 1850 summarizing these two sets of data points in FIG. 18B. For both sets of data points in FIG. 18B, the abscissa axis shows the exposure value (EV), which is a decreasing function of dimming. That is, the data points move from right to left as the light dims. The values of color temperature data points 1830 are shown on the left ordinate axis and the values of the CRI data points 1840 are shown on the right ordinate axis. These data indicate that as the light dims, both the color temperature and the CRI of the light source remains essentially unchanged. These results are also summarized in data table 1850. Data table 1850 shows that as the light dims, the CCT of the bi-color light source changes between 2882 and 2764. The data also show that the CRI of the light source remains around 90.

Some embodiments are thus capable of changing the light output and its dimming characteristics based on the combination of LEDs and the selected dimming profile. Some embodiments can change the color characteristics or diming characteristics for the same lighting system based on different variables, such as time of day, ambient light, or type of use. For example, the luminosity or color temperature may increase as evening approaches or as the ambient light dims. These changes may occur automatically based on, e.g., the time on a clock or the ambient light detected by a light sensor. Alternatively, these changes may occur in response to an input by a user. For example, in a museum, a user may chose the dimming profile of FIGS. 18A and 18B for some exhibits. As the ambient light changes during the day or on different days, the intensity of the light source may be adjusted while maintaining some other characteristics such as CCT or CRI. In the same location, however, the user may desire to switch to the dimming behavior of FIGS. 17A and 17B. This switch may enable the user to change the color of the light as it dims. Such a change may create an ambience that is desirable for a function or get together. Alternatively, a user may decide to change the color output or the dimming behavior based on the type and the colors in the illuminated object or location.

Various embodiments can achieve the above variations by using one ASIC in the lighting system. In some embodiments, one ASIC can change the relation between the inputs of different LEDs. In the bi-color embodiment of FIGS. 16 and 17, for example, the ASIC changes the relative inputs to the blue and red LEDs in accordance with the dimming input. In this embodiment, the light output in the CIE diagram of FIGS. 17A and 17B follows a relatively linear trace between the greenish yellow end 1712 and the red end 1714. Such a linear change may be different from the behavior of the incandescent or black body lights (as shown, e.g., in FIGS. 13A or 13B). The difference, however, may not be perceptible to a user.

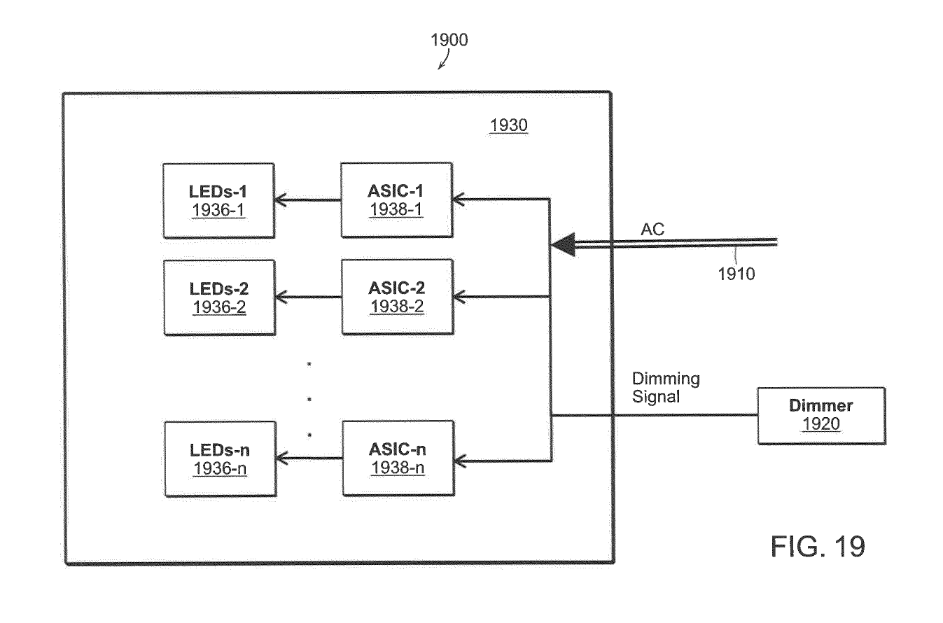

Some other embodiments, on the other hand, use more than one ASIC to generate light with more complex color or dimming characteristics. FIG. 19 depicts a block diagram of such a lighting system 1900 according to some embodiments. System 1900 includes an AC power line 1910, a dimmer 1920, and an LED assembly 1930. LED assembly 1930 includes n pairs of ASICs and LED sets, respectively labeled ASIC-1 to ASIC-n, and LEDs-1 to LEDs-n. In various embodiments, n is an integer greater than one. Each LED set LEDs-i can include one or more LEDs. Moreover, each ASIC, such as ASIC-i, controls the inputs to the corresponding LED set LED-i, where i can be one of the numbers 1 to n. In such a system, based on the dimming signal, different ASICs can independently change the characteristics of different LED sets. In some embodiments, each dimming signal is addressed to one of the ASICs and thus affects the input to the corresponding set of LEDs. These embodiments may thus provide n degrees of freedom for changing the light output, each degree of freedom corresponding to the output of one LED set. In some embodiments, each LED set corresponds to an LED bank.

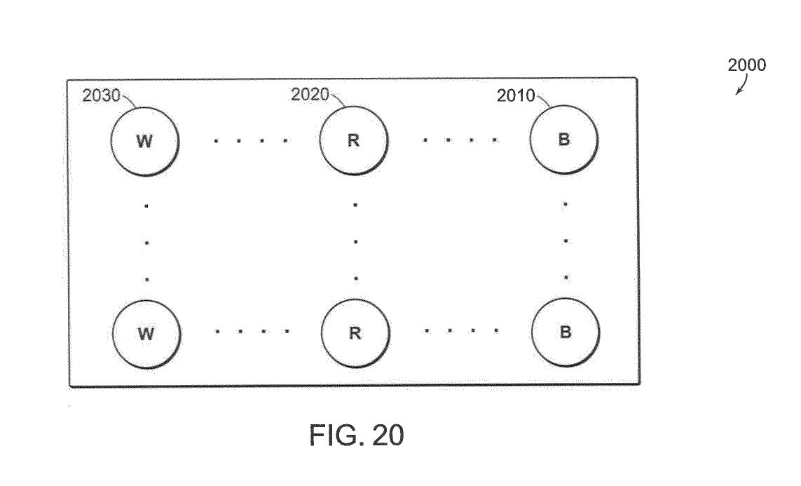

FIG. 20 shows a multi-color LED board 2000, which provides three different LED sets according to an embodiment. More specifically, LED board 2000 includes three sets of LEDs. A first LED set includes blue LEDs 2010; a second LED set includes red LEDs 2020; and a third LED set includes white LEDs 2030. Some embodiments can utilize board 2000 for generating light output with three degrees of freedom. In particular, some embodiments control the light output of each of the three LED sets with one of three ASICs.

Using three ASICs and three sets of LEDs with different color outputs enables the system to explore a two dimensional gamut in the color space. Some embodiments use more than three sets of LEDs and ASICs and thus achieve more than three degrees of freedom for exploring the gamut. Using three degrees of freedom, for example, the system may cover different points inside a triangle in the CIE diagram, while using four degrees of freedom may enable the system to cover different points inside a quadrangle area of the CIE diagram.

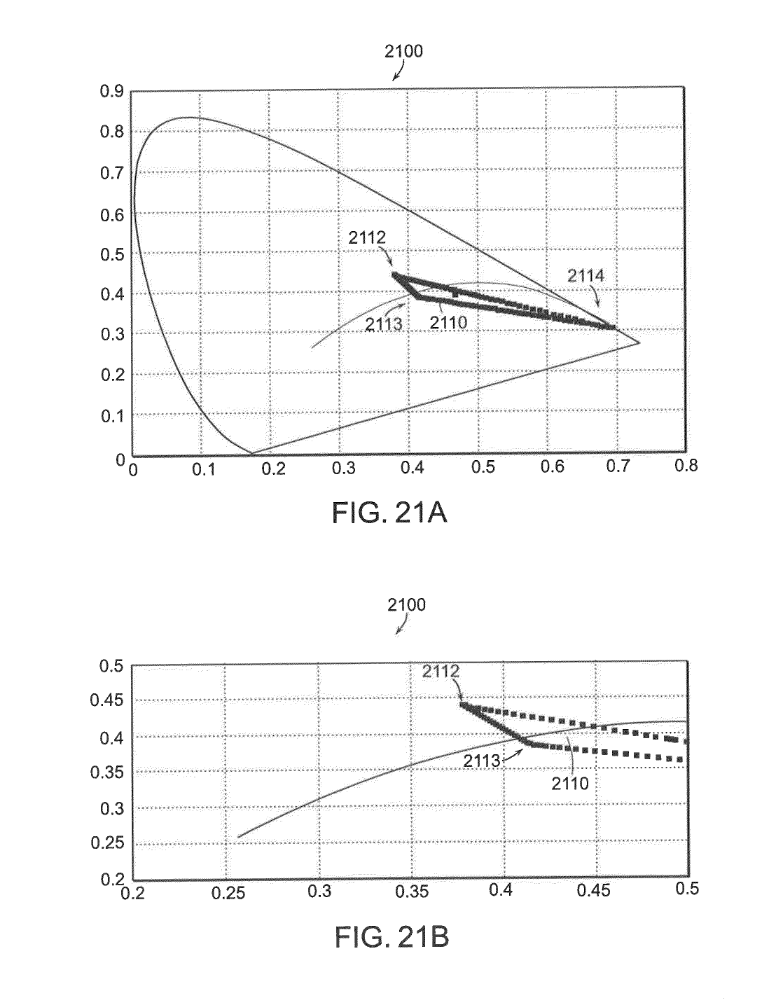

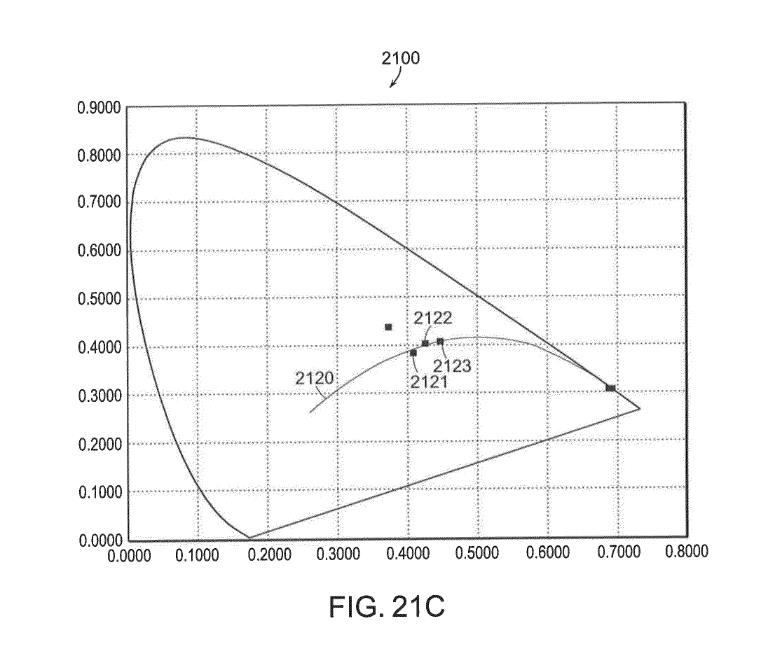

FIGS. 21A and 21B show the measured dimming profile 2110 of a tri-color light source in a CIE diagram 2100 according to an embodiment. The tri-color light source may utilize a tri-color LED board such as LED board 2000 of FIG. 20. In this embodiment, the system uses an ASIC for each of the three sets of LEDs. FIG. 21B shows the measured data section of FIG. 21A, magnified for clarity of its details.

Data points of profile 2110 show the measured values of the colors generated by the tri-color light source as it dims in different manners by the three ASICs. The three ASICs enable the system to provide all colors on or inside the triangle formed by data points 2112, 2113, and 2114. These three points respectively correspond to the colors of the blue, white, and red LEDs. The system can achieve these colors and all combination of the colors within the triangle by appropriately adjusting the input to the three LED sets.

Using three or more degrees of freedom, the system can also mimic more complex dimming behaviors. FIG. 21C shows a black body curve 2120 and exemplary dimming points 2121-2123, as implemented by a system similar to that discussed in FIGS. 21A and 21B. In this case, the ASICs change the inputs such that, as the system dims, the light output moves from point 2121 to point 2122 and point 2123. Point 2121 is located on the black body curve 2120 at or near the 3500k white point 2113 in FIGS. 21A and 21B. Points 2122 and 2123, on the other hand, move further towards the red end of the black body curve and have temperatures 3150 and 2850, respectively.

For the purposes of describing and defining the present teachings, it is noted that terms of degree (e.g., “substantially,” “slightly,” “about,” “comparable,” etc.) may be utilized herein to represent the inherent degree of uncertainty that may be attributed to any quantitative comparison, value, measurement, or other representation. Such terms of degree may also be utilized herein to represent the degree by which a quantitative representation may vary from a stated reference (e.g., about 10% or less) without resulting in a change in the basic function of the subject matter at issue.

The foregoing description of the invention, along with its associated embodiments, has been presented for purposes of illustration only. It is not exhaustive and does not limit the invention to the precise form disclosed. Those skilled in the art will appreciate from the foregoing description that modifications and variations are possible in light of the above teachings or may be acquired from practicing the invention. For example, the steps described need not be performed in the same sequence discussed or with the same degree of separation. Likewise various steps may be omitted, repeated, or combined, as necessary, to achieve the same or similar objectives. Similarly, the systems described need not necessarily include all parts described in the embodiments, and may also include other parts not described in the embodiments. Accordingly, the invention is not limited to the above-described embodiments, but instead is defined by the appended claims in light of their full scope of equivalents.

What is claimed is:

1. A lighting system, comprising:
a circuit board including a plurality of light emitting sets, each of the light emitting sets including one or more light emitting diodes;
a plurality of integrated circuits configured to receive a rectified sine waveform of a power source, wherein each one of said plurality of integrated circuits is electrically coupled to a respective one of the light emitting sets; and
a dimmer circuit electrically coupled to the integrated circuits and configured to transmit a dimming signal to the integrated circuits;
wherein each of the integrated circuits is configured to modify the rectified sine waveform into a truncated rectified sine waveform based on the dimming signal; and
wherein each of the integrated circuits is configured to turn on or off a number of the light emitting diodes included in a respective one of the light emitting sets based on the truncated rectified sine waveform.

2. The system of claim 1, wherein each of the light emitting sets includes at least one light emitting diode.

3. The system of claim 1, wherein one of the light emitting sets includes an equal number of light emitting diodes as another one of the light emitting sets.

4. The system of claim 1, further comprising a rectifier circuit electrically coupled to the integrated circuits and configured to generate the rectified sine waveform of the power source.

5. The system of claim 1, wherein the dimming signal comprises at least one of a DMX signal, a digital addressable lighting interface (DALI) signal, a power-line communication signal, a global dimming signal having a voltage between 0-10 volts, a Bluetooth signal, a Bluetooth Low Energy signal, a WIFI signal, a Zigbee signal, and a visible light signal.

6. The system of claim 1, wherein the dimmer circuit is electrically coupled to the integrated circuits through at least one circuit protector.

7. The system of claim 6, wherein the at least one circuit protector comprises at least one of a capacitor, a Zener diode, an opto-isolator, and a combination thereof.

8. The system of claim 1, wherein each of the integrated circuits is configured to sequentially turn on the respective one of the light emitting sets in a first quarter wave cycle of the rectified sine waveform and to sequentially turn off the respective one of the light emitting sets in a second quarter wave cycle of the rectified sine waveform following the first quarter cycle.

9. The system of claim 1, wherein each of the light emitting sets comprises at least one white color light emitting diode.

10. The system of claim 1, wherein the light emitting sets comprise at least one light emitting diode of a first color and at least one light emitting diode of a second color different from the first color.

11. The system of claim 10, wherein the first color is white and the second color is red.

12. The system of claim 1, wherein the light emitting sets comprise at least one light emitting diode of a first color, at least one light emitting diode of a second color different from the first color, and at least one light emitting diode of a third color different from the first color and the second color.

13. The system of claim 12, wherein the first color is white, the second color is red, and the third color is blue.
